(19) United States
(12) Patent Application Publication
(10) Pub. No.: US 2025/0219385 A1
(43) Pub. Date: Jul. 3, 2025

(54) CABLE SPLICING DEVICE HAVING A COUPLING PORTION THAT IS CONFIGURED TO MOVE RELATIVE TO A CONDUCTING PORTION SO AS TO IMPROVE INSTALLATION VERSATILITY AND/OR ELECTRICAL PERFORMANCE

(71) Applicant: PPC BROADBAND, INC., East Syracuse, NY (US)

(72) Inventor: Daniel DAOUST, Syracuse, NY (US)

(73) Assignee: PPC BROADBAND, INC., East Syracuse, NY (US)

(21) Appl. No.: 19/005,492

(22) Filed: Dec. 30, 2024

Related U.S. Application Data
(60) Provisional application No. 63/615,617, filed on Dec. 28, 2023.

(51) Int. Cl. H02G 15/10

(52) U.S. Cl. CPC H02G 15/10

(57) ABSTRACT

A cable splicing device having a coupling portion structurally configured to move relative to a conducting portion to permit adjustment of a relative orientation between communication cables. The device may include a first connecting portion having a first cable interface port, a second cable interface port, and a first coupling portion and a second connecting portion having a third cable interface port, a fourth cable interface port, and a second coupling portion. The first coupling portion may be structurally configured to move between a first position operatively associated with the first cable interface port and a second position operatively associated with the second cable interface port so as to permit adjustment of an angular orientation of the first coupling portion relative to the second coupling portion and improve installation versatility and/or electrical performance.

### CROSS-REFERENCE TO RELATED APPLICATION

This application claims the benefit of U.S. Provisional Patent Application No. 63/615,617, filed on Dec. 28, 2023, the disclosure of which is hereby incorporated by reference herein in its entirety.

### TECHNICAL FIELD

The present disclosure relates generally to hardline cable splicing devices, and more particularly to a hardline cable splicing device having pin receiving portions that are configured to move relative to a conducting portion so as to permit selective adjustment of an angular orientation between a first communication cable and a second communication cable that are electrically coupled with the splice block.

### BACKGROUND

Hardline splice blocks are used to connect two coaxial cables. A conventional hardline splice block has four cable ports. One cable port is used as an inlet port and the other three cable ports are outlets ports to allow the direction of the outlet cable to be different than the inlet cable if desired (i.e., a “thru orientation splice, a 90-degree orientation splice, and a 180-degree orientation splice). Due to the nature of the conventional hardline splice block, two outlet ports are unused because only two ports (one inlet and one outlet) can be used. The unused ports and corresponding internal components configured for forming an electrical coupling act as antennae resulting in a degraded signal quality.

There is a need for simple cable splice device that is structurally configured to permit selection of multiple cable orientations without having unused cable ports causing signal degradation. Accordingly, it may be desirable to provide a cable splice block that includes coupling portions that are configured to move relative to a conducting portion so as to permit adjustment of an angular orientation of first and second communication cables attached to the device to improve installation.

### SUMMARY

The present disclosure provides a cable splicing device having a coupling portion structurally configured to move relative to a conducting portion to permit adjustment of a relative orientation between communication cables to improve installation versatility and/or electrical performance.

In some embodiments, the cable splicing device may include a first end portion having a first connecting portion structurally configured to connect to a first communication cable, a second end portion opposite the first end portion and structurally configured to connect to a second communication cable, and a conducting portion structurally configured to electrically couple the first connecting portion with the second connecting portion.

In some embodiments, the first connecting portion may include a first longitudinal cable interface port, a first lateral cable interface port, and a first pin receiving portion.

In some embodiments, the second connecting portion may include a second longitudinal cable interface port, a second lateral cable interface port, and a second pin receiving portion.

In some embodiments, the first pin receiving portion may be structurally configured to move relative to the conducting portion between a first position operatively associated with the first longitudinal cable interface port and a second position operatively associated with the first lateral cable interface port.

In some embodiments, the second pin receiving portion may be structurally configured to move relative to the conducting portion between a third position operatively associated with the second longitudinal cable interface port and a fourth position operatively associated with the second lateral cable interface port.

In some embodiments, the first pin receiving portion may be structurally configured to move independent of the second pin receiving portion.

In some embodiments, the first pin receiving portion may be structurally configured to pivot between the first position and the second position. In some embodiments, the second pin receiving portion may be structurally configured to pivot between the third position and the fourth position so as to permit adjustment of an angular orientation of the first pin receiving portion relative to the second pin receiving portion and improve installation versatility and/or electrical performance.

In some embodiments, the first pin receiving portion may be structurally configured to move independent of the second pin receiving portion.

In some embodiments, the first pin receiving portion and the second pin receiving portion may be structurally configured to selectively electrically couple a first communication cable with a second communication cable in a pass-through orientation, a 90-degree orientation, and a 180-degree orientation.

In some embodiments, the cable splicing device may be structurally configured to allow relative orientation between a first communication cable and a second communication cable electrically coupled with the cable splicing device to be adjusted without the cable splicing device having an used pin receptacle.

In some embodiments, a cable splicing device may have a coupling portion structurally configured to move relative to a conducting portion to permit adjustment of a relative orientation between communication cables. In some embodiments, the cable splicing device may include a first end portion having a first connecting portion structurally configured to connect to the first communication cable, a second end portion opposite the first end portion and having a second connecting portion structurally configured to connect to the second communication cable, and a conducting portion structurally configured to electrically couple the first connecting portion with the second connecting portion.

In some embodiments, the first connecting portion may include a first longitudinal cable interface port, a first lateral cable interface port, and a first coupling portion.

In some embodiments, the second connecting portion may include a second longitudinal cable interface port, a second lateral cable interface port, and a second coupling portion.

In some embodiments, the first coupling portion may be structurally configured to move between a first position operatively associated with the first longitudinal cable interface port and a second position operatively associated with the first lateral cable interface port.

In some embodiments, the second coupling portion may be structurally configured to move between a third position operatively associated with the second longitudinal cable interface port and a fourth position operatively associated with the second lateral cable interface port so as to permit adjustment of an angular orientation of the first coupling portion relative to the second coupling portion and improve installation versatility and/or electrical performance.

In some embodiments, the first coupling portion may be structurally configured to move independent of the second coupling portion.

In some embodiments, the first coupling portion may be structurally configured to pivot between the first position and the second position and the second coupling portion may be structurally configured to pivot between the third position and the fourth position.

In some embodiments, the cable splicing device may include a conducting portion structurally configured to electrically couple the first coupling portion to the second coupling portion.

In some embodiments, the first coupling portion may include a first pin receiving portion configured to receive a center conductor of a coaxial cable. In some embodiments, the second coupling portion may include a second pin receiving portion configured to receive a center conductor of a coaxial cable.

In some embodiments, the cable splicing device may be structurally configured to allow relative orientation between a first communication cable and a second communication cable electrically coupled with the cable splicing device to be adjusted without the cable splicing device having an used pin receptacle.

In some embodiments, the first coupling portion and the second coupling portion may be structurally configured to selectively electrically couple a first communication cable with a second communication cable in a pass-through orientation, a 90-degree orientation, and a 180-degree orientation.

In some embodiments, a cable splicing device may have a coupling portion structurally configured to move relative to a conducting portion to permit adjustment of a relative orientation between communication cables.

In some embodiments, the cable splicing device may include a first connecting portion structurally configured to connect to the first communication cable and a second connecting portion structurally configured to connect to the second communication cable.

In some embodiments, the first connecting portion may include a first cable interface port, a second cable interface port, and a first coupling portion.

In some embodiments, the second connecting portion may include a third cable interface port, a fourth cable interface port, and a second coupling portion.

In some embodiments, the first coupling portion may be structurally configured to move between a first position operatively associated with the first cable interface port and a second position operatively associated with the second cable interface port so as to permit adjustment of an angular orientation of the first coupling portion relative to the second coupling portion and improve installation versatility and/or electrical performance.

In some embodiments, the first cable interface port may include a first longitudinal port, the second cable interface port may include a first lateral port, the third cable interface port may include a second longitudinal portion, and the fourth cable interface port may include a second lateral port.

In some embodiments, the first coupling portion may include a first pin receiving portion structurally configured to receive a first male end of the first communication cable. In some embodiments, the second coupling portion may include a second pin receiving portion structurally configured to receive a second male end of the second communication cable.

In some embodiments, the first coupling portion may be structurally configured to move independent of the second coupling portion.

In some embodiments, the second coupling portion may be structurally configured to move between a third position operatively associated with the third cable interface port and a fourth position operatively associated with the fourth cable interface port.

In some embodiments, the first coupling portion may be structurally configured to pivot between the first position and the second position. In some embodiments, the second coupling portion may be structurally configured to pivot between the third position and the fourth position.

In some embodiments, the cable splicing device may include a conducting portion structurally configured to electrically couple the first coupling portion to the second coupling portion.

In some embodiments, the cable splicing device may be structurally configured to allow relative orientation between a first communication cable and a second communication cable electrically coupled with the cable splicing device to be adjusted without the cable splicing device having an used pin receptacle.

In some embodiments, the first coupling portion and the second coupling portion may be structurally configured to selectively electrically couple a first communication cable with a second communication cable in a pass-through orientation, a 90-degree orientation, and a 180-degree orientation.

Various aspects of the system, as well as other embodiments, objects, features and advantages of this disclosure, will be apparent from the following detailed description of illustrative embodiments thereof, which is to be read in conjunction with the accompanying drawings.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a schematic representation of an example cable splicing device connecting a first communication cable to a second communication cable.

FIG. 2 is a sectioned isometric view of an example cable splicing device in a first cable orientation.

FIG. 3 is a side section view of the cable splicing device of FIG. 1.

FIG. 4 is a side section view of the cable splicing device of FIG. 1 in a second cable orientation.

FIG. 5 is a side section view of the cable splicing device of FIG. 1 in a third cable orientation.

### DETAILED DESCRIPTION

Reference will now be made in detail to presently preferred embodiments and methods of the present disclosure, which constitute the best modes of practicing the present disclosure presently known to the inventors. The figures are not necessarily drawn to scale. It is to be understood, however, that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

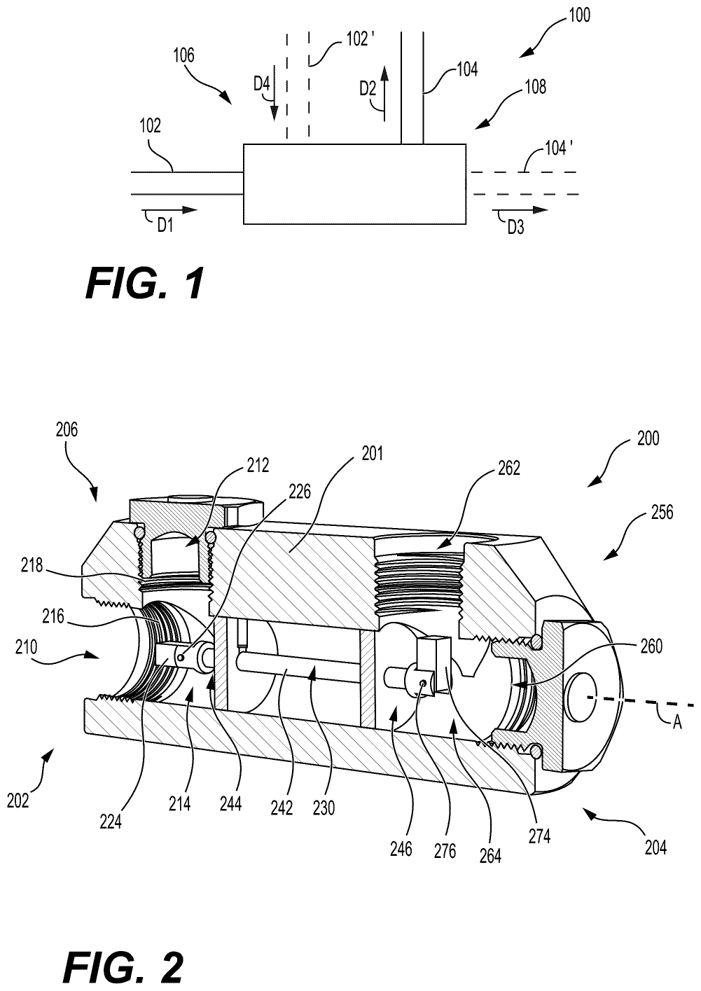

Embodiments of the disclosure provide a cable splicing device 100 structurally configured to electrically or communicatively couple (e.g., allow for the transmission of a signal) a first communication cable 102 (e.g., a coaxial cable) to a second communication cable 104 (e.g., a coaxial cable), as schematically shown in FIG. 1. In some implementations, the cable splicing device 100 may include a first portion 106 structurally configured to connect to the first communication cable 102 and a second portion 108 structurally configured to connect to the second communication cable 104.

In some implementations, the cable splicing device 100 may be structurally configured to provide multiple orientations in which the first communication cable 102 and the second communication cable 104 may be arranged relative to each other. For example, in some implementations, the first portion 106 may include a first connection portion 110 structurally configured to provide a plurality of positions which the first communication cable 102 can connect to the first portion 106. In some implementations, the second portion 108 may include a second connection portion 112 structurally configured to provide a plurality of positions which the second communication cable 104 can connect to the second portion 108.

For example, FIG. 1 illustrates the first communication cable 102 and the second communication cable 104 in a 90-degree orientation (i.e., the first communication cable 102 extends into the cable splicing device 100 in a first direction D1 and the second communication cable 104 extends from the cable splicing device 100 in a second direction D2 that is 90 degrees from the first direction D1). The first communication cable 102 and the second communication cable 104, however, may connect to the cable splicing device 100 in other orientations.

For example, in some implementations, the first communication cable 102 and the second communication cable may be connected to the cable splicing device 100 in a pass-through orientation, illustrated by the second communication cable 104′ in dashed lines. Thus, the first communication cable 102 may extend into the cable splicing device in the first direction D1 and the second communication cable 104′ may extend from the cable splicing device 100 in a third direction D3 that is parallel or coaxial with the first direction D1.

In some implementations, the first communication cable 102 and the second communication cable 104 may be connected to the cable splicing device 100 in a 180-degree orientation, illustrated by the first communication cable 102′ in dashed lines. Thus, the first communication cable 102′ may extend into the cable splicing device a fourth direction D4 and the second communication cable 104 may extend from the cable splicing device 100 in the second direction D2 that is parallel to and opposite the fourth direction D4.

In some implementations, the cable splicing device 100 may be structurally configured to provide multiple orientations in which the first communication cable 102 and the second communication cable 104 can be arranged relative to each other without having excess electrical coupling means (e.g., excess pin receiving portions) that are unused.

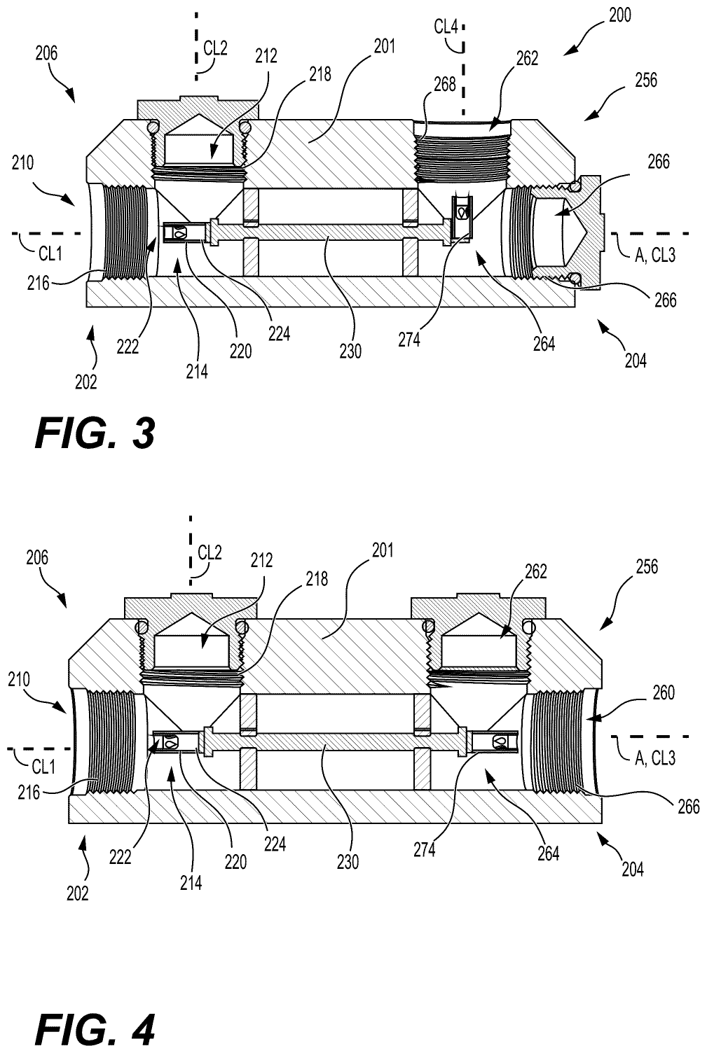

FIGS. 2-3 illustrate an example cable splicing device 200 according to the present disclosure in a first orientation. The cable splicing device 200 may be structurally configured to operatively connect (e.g., electrically couple) the first communication cable 102 to the second communication cable 104. The cable splicing device 200 may be configured in a variety of ways.

In some implementations, the cable splicing device 200 may include a body portion 201. The body portion 201 may be structurally configured in a variety of ways, including shape, size, and materials. In some implementations, the body portion 201 may be formed as a monolithic block. In other implementations, however, the body portion 201 may include multiple pieces. The body portion 201 may be made from any suitable material, such as aluminum, brass, plastic, etc.

In some implementations, the body portion 201 may include a first end portion 202, a second end portion 204 opposite the first end portion, and a longitudinal axis A. The first end portion 202 may include a first connecting portion 206 structurally configured to connect to the first communication cable 102. The first connecting portion 206 may be configured in a variety of ways, such as for example, any known or suitable connection type for a communication cable. In some implementations, the first connecting portion 206 may include multiple cable interface ports arranged in different orientations (e.g., parallel or coaxial with the longitudinal axis A, orthogonal to the longitudinal axis A, oblique to the longitudinal axis). The number of and the orientation of the multiple cable interface ports may vary in different implementations. Each of the multiple cable interface ports may be structurally configured to connect to the first communication cable 102.

For example, in some implementations, the first connecting portion 206 may include a first longitudinal cable interface port 210, a first lateral cable interface port 212, and a first coupling portion 214 (e.g., a pin receiving portion or pin receptacle). In some implementations, the first longitudinal cable interface port 210 may be a female port having internal threads 216 and a first centerline CL1 that is coaxial with, or parallel with the longitudinal axis A. In some implementations, the first lateral cable interface port 212 may be a female port having internal threads 218 and a second centerline CL2 that is perpendicular to, or oblique to, the longitudinal axis A.

The first coupling portion 214 can be configured in a variety of ways. In some implementations, the first coupling portion 214 may be structurally configured to electrically couple to the first communication cable 102. For example, in some implementations, the first communication cable 102 may include a conductor pin (not shown) (e.g., a conventional pin/male center of a coaxial cable) and the first coupling portion 214 may be structurally configured to connect to the conductor pin (e.g., receive the conductor pin). In some implementations, each of the internal threads 216 of the first longitudinal cable interface port 210 and the internal threads 218 of the first lateral cable interface port 212 may be structurally configured to mate with complementary external threads (not shown) on the first communication cable 102.

In some implementations, the first coupling portion 214 may have a tubular shape with one or more sidewall portions 220 that taper inward to form a central passage 222 (FIG. 3). The sidewall portions 220 may be structurally configured to engage the conductor pin (not shown) of the first communication cable 102 when the conductor pin is received through the central passage 222. Thus, the first coupling portion 214 may act as a pin receptacle or pin receiving portion. In some implementations, the first coupling portion 214 may be supported within a first housing portion 224 that may be structurally configured to support and electrically couple to the first coupling portion 214.

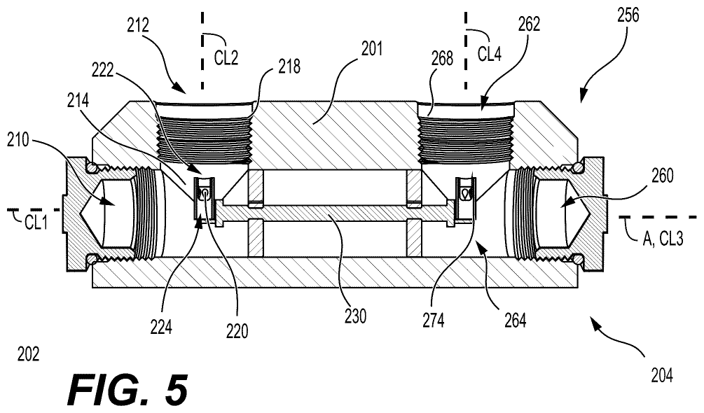

The first coupling portion 214 may be structurally configured to move between a first position that is operatively associated with the first longitudinal cable interface port 210 and a second position that is operatively associated with the first lateral cable interface port 212. In some implementations, the central passage 222 is coaxially aligned with the first centerline CL1 in the first position, as shown in FIG. 3. In some implementations, the central passage 222 is coaxially aligned with the second centerline CL2 in the second position, as shown in FIG. 5.

The first coupling portion 214 may move between the first position and the second position in a variety of ways. In some implementations, the first coupling portion 214 may be structurally configured to pivot between the first position and the second position. For example, in some implementations, the first housing portion 224 may be structurally configured to pivot about a pivot pin 226 (FIG. 2). The first coupling portion 214 being supported within the first housing portion 224 may move with the first housing portion 224. In other implementations, the cable splicing device 200 may not include the first housing portion 224 and the first coupling portion 214 may be directly mounted within the cable splicing device 100 by the pivot pin 226.

In some implementations, the cable splicing device 200 may include a conducting portion 230 structurally configured to electrically couple the first end portion 202 to the second end portion 204. The conducting portion 230 can be configured in a variety of ways. For example, the conducting portion 230 may include any suitable electrical conducting material (e.g., a conducting metal such as copper). In some implementations, the conducting portion 230 may have an elongated body portion 242 (e.g., rod, pin, shaft, block, etc.) having a proximal end portion 244 and a distal end portion 246 opposite the proximal end portion. In some implementations, the elongated body portion 242 may extend coaxially, or parallel to, the longitudinal axis A.

In some implementations, the first housing portion 224 may be connected to the proximal end portion 244 of the conducting portion 230 by the pivot pin 226. In some implementations, the first coupling portion 214 may be structurally configured to remain in position (i.e., the first position or the second position) unless intentionally moved to another position. For example, in some implementations, the first housing portion 224 may be connected to the proximal end portion 244 such that the first housing portion 224 may pivot about the pivot pin 226 but be held in position by friction between the first housing portion 224 and the proximal end portion 244.

In some implementations, the first coupling portion 214 may be structurally configured to be manually moved between the first position and the second position. For example, the first coupling portion 214 may be engaged by an object (e.g., a conventional pin/male center of a coaxial cable) to manually move the first coupling portion 214 between the first position and the second position.

In some implementations, the second end portion 204 may include a second connecting portion 256 structurally configured to connect to the second communication cable 104. The second connecting portion 256 may be configured in a variety of ways, such as for example, any known or suitable connection type for a communication cable. In some implementations, the second connecting portion 256 may include multiple ports arranged in different orientations (e.g., parallel or coaxial with the longitudinal axis A, orthogonal to the longitudinal axis A, oblique to the longitudinal axis). The number of and the orientation of the multiple ports may vary in different implementations. Each of the multiple ports may be structurally configured to connect to the second communication cable 104.

In some implementations, the second connecting portion 256 may be structurally configured the same as, or similar to, the first connecting portion 206. Thus, the description of the first connecting portion 206 applies equally to the second connecting portion 256. For example, in some implementations, the second connecting portion 256 may include a second longitudinal cable interface port 260, a second lateral cable interface port 262, and a second coupling portion 264 (e.g., a pin receiving portion or pin receptacle). In some implementations, the second longitudinal cable interface port 260 may be a female port having internal threads 266 and a third centerline CL3 that is coaxial with, or parallel with the longitudinal axis A. In some implementations, the second lateral cable interface port 262 may be a female port having internal threads 268 and a fourth centerline CL4 that is perpendicular to, or oblique to, the longitudinal axis A.

The second coupling portion 264 can be configured in a variety of ways. In some implementations, the second coupling portion 264 may be structurally configured to electrically couple to the second communication cable 104. In some implementations, the second coupling portion 264 may be supported within a second housing portion 274 structurally configured to support and electrically couple to the second coupling portion 264.

The second coupling portion 264 may be structurally configured to move between a third position that is operatively associated with the second longitudinal cable interface port 260 and a fourth position that is operatively associated with the second lateral cable interface port 262. In some implementations, the second coupling portion 264 may be coaxially aligned with the third centerline CL3 in the third position, as shown in FIG. 4. In some implementations, the second coupling portion 264 may be coaxially aligned with the fourth centerline CL4 in the fourth position, as shown in FIG. 3.

The second coupling portion 264 may move between the third position and the fourth position in a variety of ways. In some implementations, the second coupling portion 264 may be structurally configured to pivot about a pivot pin 276 (FIG. 2) between the third position and the fourth position. In some implementations, the second housing portion 274 may be connected to the distal end portion 246 of the conducting portion 230 by the pivot pin 276. In some implementations, the second coupling portion 264 may be structurally configured to remain in position (i.e., the third position or the fourth position) unless intentionally moved to another position. In some implementations, the second coupling portion 264 may be structurally configured to be manually moved between the third position and the fourth position. In some implementations, the first coupling portion 214 is structurally configured to move independent of the second coupling portion 264.

FIGS. 2-3 illustrate the cable splicing device 200 in a 90-degree orientation. In the 90-degree orientation, the first coupling portion 214 is in the first position such that the first communication cable 102 may be received in the first longitudinal cable interface port 210 and electrically coupled to the first coupling portion 214. In the illustrated 90-degree orientation, the second coupling portion 264 is in the fourth position such that the second communication cable 104 may be received in the second lateral cable interface port 262 and electrically coupled to the second coupling portion 264. The conducting portion 230 may be structurally configured to electrically couple the first coupling portion 214 to the second coupling portion 264; thus, the cable splicing device 200 may operatively connect (e.g., electrically couple) the first communication cable 102 to a second communication cable 104.

The cable splicing device 200 may also be arranged in a 90-degree orientation with the first coupling portion 214 is in the second position such that the first communication cable 102 may be received in the first lateral cable interface port 212 and electrically coupled to the first coupling portion 214 and the second coupling portion 264 in the third position such that the second communication cable 104 may be received in the second longitudinal cable interface port 260 and electrically coupled to the second coupling portion 264.

FIG. 4 illustrates the cable splicing device 200 in a pass-through orientation. In the pass-through orientation, the first coupling portion 214 is in the first position such that the first communication cable 102 may be received in the first longitudinal cable interface port 210 and electrically coupled to the first coupling portion 214. In the illustrated pass-through orientation, the second coupling portion 264 is in the third position such that the second communication cable 104 may be received in the second longitudinal cable interface port 260 and electrically coupled to the second coupling portion 264.

FIG. 5 illustrates the cable splicing device 200 in a 180-degree orientation. In the 180-degree orientation, the first coupling portion 214 is in the second position such that the first communication cable 102 may be received in the first lateral cable interface port 212 and electrically coupled to the first coupling portion 214. In the illustrated 180-degree orientation, the second coupling portion 264 is in the fourth position such that the second communication cable 104 may be received in the second lateral cable interface port 262 and electrically coupled to the second coupling portion 264.

As shown and described, the cable splicing device 200 is structurally configured to provide a hardline splice between the first communication cable 102 and the second communication cable 104 while allowing the orientation between the first communication cable 102 and the second communication cable 104 to be adjusted (e.g., between 90-degree, 180-degree, and pass-through orientations) relative to the cable splicing device 200. The cable splicing device 200 provides the ability to adjust the orientation between the first communication cable 102 and the second communication cable 104 without having any additional pin receptacles (e.g., a separate pin receptacle for each port) that is unused (i.e., not electrically coupled to a communication cable). Thus, the cable splicing device 200 does not have unused coupling portions (e.g., pin receptacles) that can act as antennae resulting in a degraded signal quality.

The disclosed cable splicing device may be configured to improve installation versatility. For example, allowing the orientation between the first communication cable 102 and the second communication cable 104 to be adjusted (e.g., between 90-degree, 180-degree, and pass-through orientations) relative to the cable splicing device 200 may allow the cable splicing device to be used in a variety of applications where orientation of the cables may vary. Further, eliminating unused ports may provide improved electrical performance. For example, the unused ports and corresponding internal components on a conventional four fixed port splice block may form an electrical coupling that act as antennae, which may result in a degraded signal quality. By eliminating the unused ports, the disclosed cable splicing device avoids that concern. For example, when electrically (gated return loss) tested, some conventional splice blocks have shown a return loss of 9 dB out to 3 GHz while the disclosed cable splicing device shows a return loss of 20 dB out to 3 GHz.

While at least one example, non-limiting embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A cable splicing device having a coupling portion structurally configured to move relative to a conducting portion to permit adjustment of a relative orientation between communication cables, comprising:
a first end portion having a first connecting portion structurally configured to connect to a first communication cable;
a second end portion opposite the first end portion, the second end portion having a second connecting portion structurally configured to connect to a second communication cable;
a conducting portion structurally configured to electrically couple the first connecting portion with the second connecting portion;
wherein the first connecting portion includes a first longitudinal cable interface port, a first lateral cable interface port, and a first pin receiving portion;
wherein the second connecting portion includes a second longitudinal cable interface port, a second lateral cable interface port, and a second pin receiving portion;
wherein the first pin receiving portion is structurally configured to move relative to the conducting portion between a first position operatively associated with the first longitudinal cable interface port and a second position operatively associated with the first lateral cable interface port;
wherein the second pin receiving portion is structurally configured to move relative to the conducting portion between a third position operatively associated with the second longitudinal cable interface port and a fourth position operatively associated with the second lateral cable interface port;
wherein the first pin receiving portion is structurally configured to move independent of the second pin receiving portion;
wherein the first pin receiving portion is structurally configured to pivot between the first position and the second position, and wherein the second pin receiving portion is structurally configured to pivot between the third position and the fourth position so as to permit adjustment of an angular orientation of the first pin receiving portion relative to the second pin receiving portion and improve installation versatility and/or electrical performance.

2. The cable splicing device of claim 1, wherein the first pin receiving portion is structurally configured to move independent of the second pin receiving portion.

3. The cable splicing device of claim 1, wherein the first pin receiving portion and the second pin receiving portion are structurally configured to selectively electrically couple a first communication cable with a second communication cable in a pass-through orientation, a 90-degree orientation, and a 180-degree orientation.

4. The cable splicing device of claim 1, wherein the cable splicing device is structurally configured to allow relative orientation between a first communication cable and a second communication cable electrically coupled with the cable splicing device to be adjusted without the cable splicing device having an used pin receptacle.

5. A cable splicing device having a coupling portion structurally configured to move relative to a conducting portion to permit adjustment of a relative orientation between communication cables, comprising:
a first end portion having a first connecting portion structurally configured to connect to the first communication cable;
a second end portion opposite the first end portion, the second end portion having a second connecting portion structurally configured to connect to the second communication cable;
a conducting portion structurally configured to electrically couple the first connecting portion with the second connecting portion;
wherein the first connecting portion includes a first longitudinal cable interface port, a first lateral cable interface port, and a first coupling portion;
wherein the second connecting portion includes a second longitudinal cable interface port, a second lateral cable interface port, and a second coupling portion;
wherein the first coupling portion is structurally configured to move between a first position operatively associated with the first longitudinal cable interface port and a second position operatively associated with the first lateral cable interface port, and wherein the second coupling portion is structurally configured to move between a third position operatively associated with the second longitudinal cable interface port and a fourth position operatively associated with the second lateral cable interface port so as to permit adjustment of an angular orientation of the first coupling portion relative to the second coupling portion and improve installation versatility and/or electrical performance.

6. The cable splicing device of claim 5, wherein the first coupling portion is structurally configured to move independent of the second coupling portion.

7. The cable splicing device of claim 5, wherein the first coupling portion is structurally configured to pivot between the first position and the second position and the second coupling portion is structurally configured to pivot between the third position and the fourth position.

8. The cable splicing device of claim 5, wherein the cable splicing device further comprises a conducting portion structurally configured to electrically couple the first coupling portion to the second coupling portion.

9. The cable splicing device of claim 5, wherein the first coupling portion includes a first pin receiving portion configured to receive a center conductor of a coaxial cable, and the second coupling portion includes a second pin receiving portion configured to receive a center conductor of a coaxial cable.

10. The cable splicing device of claim 9, wherein the cable splicing device is structurally configured to allow relative orientation between a first communication cable and a second communication cable electrically coupled with the cable splicing device to be adjusted without the cable splicing device having an used pin receptacle.

11. The cable splicing device of claim 5, wherein the first coupling portion and the second coupling portion are structurally configured to selectively electrically couple a first communication cable with a second communication cable in a pass-through orientation, a 90-degree orientation, and a 180-degree orientation.

12. A cable splicing device having a coupling portion structurally configured to move relative to a conducting portion to permit adjustment of a relative orientation between communication cables, comprising:
a first connecting portion structurally configured to connect to the first communication cable;
a second connecting portion structurally configured to connect to the second communication cable;
wherein the first connecting portion includes a first cable interface port, a second cable interface port, and a first coupling portion;
wherein the second connecting portion includes a third cable interface port, a fourth cable interface port, and a second coupling portion;
wherein the first coupling portion is structurally configured to move between a first position operatively associated with the first cable interface port and a second position operatively associated with the second cable interface port so as to permit adjustment of an angular orientation of the first coupling portion relative to the second coupling portion and improve installation versatility and/or electrical performance.

13. The cable splicing device of claim 12, wherein the first cable interface port is a first longitudinal port, the second cable interface port is a first lateral port, the third cable interface port is a second longitudinal portion, and the fourth cable interface port is a second lateral port.

14. The cable splicing device of claim 12, wherein the first coupling portion includes a first pin receiving portion structurally configured to receive a first male end of the first communication cable and the second coupling portion includes a second pin receiving portion structurally configured to receive a second male end of the second communication cable.

15. The cable splicing device of claim 12, wherein the first coupling portion is structurally configured to move independent of the second coupling portion.

16. The cable splicing device of claim 12, wherein the second coupling portion is structurally configured to move between a third position operatively associated with the third cable interface port and a fourth position operatively associated with the fourth cable interface port.

17. The cable splicing device of claim 16, wherein the first coupling portion is structurally configured to pivot between the first position and the second position and the second coupling portion is structurally configured to pivot between the third position and the fourth position.

18. The cable splicing device of claim 12, further comprises a conducting portion structurally configured to electrically couple the first coupling portion to the second coupling portion.

19. The cable splicing device of claim 12, wherein the cable splicing device is structurally configured to allow relative orientation between a first communication cable and a second communication cable electrically coupled with the cable splicing device to be adjusted without the cable splicing device having an used pin receptacle.

20. The cable splicing device of claim 12, wherein the first coupling portion and the second coupling portion are structurally configured to selectively electrically couple a first communication cable with a second communication cable in a pass-through orientation, a 90-degree orientation, and a 180-degree orientation.
